(19) United States
(12) Patent Application Publication
(10) Pub. No.: US 2010/0044524 A1
(43) Pub. Date: Feb. 25, 2010

(54) JOINT STRUCTURE OF CABLE RACKS

(75) Inventors: Keiichi SUGAYA, Tokyo (JP); Hideo OKI, Tokyo (JP)

Correspondence Address: Studebaker & Brackett PC, One Fountain Square, 11911 Freedom Drive, Suite 750, Reston, VA, 20190, US

(73) Assignee: BURESUTO KOGYO CO., LTD., Tokyo (JP)

(21) Appl. No.: 12/540,906

(22) Filed: Aug. 13, 2009

(30) Foreign Application Priority Data
Aug. 19, 2008 (JP) 2008-210553

(51) Int. Cl. F16L 3/00

(52) U.S. Cl. 248/49

(57) ABSTRACT

Disclosed is a cable rack joint structure, which is designed to bite into an inner peripheral surface of a bolt insertion hole so as to establish sufficient electrical conduction between cable racks. In the cable rack joint structure, a bolt insertion hole 9 is formed in a circular shape, which allows only a distal end of a polygonal neck portion 6 of a joint bolt 5 to be inserted thereinto. The bolt insertion hole 9 has a plurality of recesses 9A formed in an inner peripheral surface thereof and adapted to lock respectively at least two of three or more corner edges 6A of the neck portion 6, in such a manner that the inner peripheral surface of the bolt insertion hole 9 is bitten into at respective positions where the corner edges 6A of the neck portion 6 are locked by corresponding ones of the recesses 9A. The cable rack joint structure of the present invention can reliably prevent corotation which otherwise occurs between the joint bolt and locking nut, such as a hot-dip galvanized bolt and nut, during an operation of tightly fastening them together, and allow a shape of the bolt insertion hole to be intuitively recognized as that of a standard bolt insertion hole so as to minimize the time and effort needed on activities for familiarizing operations with the bolt insertion hole so they know it is a proper bolt insertion hole.

### BACKGROUND OF THE INVENTION

The present invention relates to a cable rack joint structure designed to ensure electrical conduction between cable racks, and more specifically, to a cable rack joint structure designed to prevent corotation of a bolt and a nut, such as a hot-dip galvanized bolt and nut, which occurs while tightly fastening them together.

Heretofore, there have been proposed various types of metal cable racks for cable wiring, which are different in shape and structure. In consideration of weather, rust, salt, moisture, and chemical resistance and the like so as to be adaptable to environmental changes in an installation site, most of the cable racks are coated with a particular surface-finishing film, such as a baked melamine coating, or an epoxy resin-based coating excellent in rust protection capability. However, if cable racks with such a surface finish are installed by simply joining them together, it is undesirable because they will be incapable of electrical conduction therebetween because such a surface finish film has no electrical conductivity. This causes a problem that, when current leakage occurs in a cable laid out along the cable racks incapable of mutual electrical conduction, the current cannot bypass therethrough.

In order to solve the problem, some techniques have been proposed, for example, joining adjacent cable racks using an earth bonding device as in Japanese Utility Model Publication No. 55-043700B, providing a protrusion as in Japanese Utility Model Laid-open No. 54-048399A or providing saw tooth-like portions as in Japanese Utility Model Laid-open No. 56-051414A on a seating surface of each of a bolt and a nut in order to forcibly peel the coating film on the cable racks.

In the above conventional techniques, there remain problems that a lot of time and effort are required for conducting the cable-rack joining operation in the structure stated in Japanese Utility Model Publication No. 55-043700B, and peeled film fractions ride on the protrusion or the like-like portions which causes difficulty in further peeling the film in the structures stated in Japanese Utility Model Laid-open No. 54-048399A. In order to solve these problems, the inventor of the present invention invented the structure disclosed in Japanese Patent Publication No. 04-004808B, regarding a technique has been widely employed in joining cable racks.

In the technique disclosed in Japanese Patent Publication No. 04-004808B, electrically conductivity between the cable racks is ensured through the use of fastening means including an electrically-conductive joint bolt and an electrically-conductive nut threadably fastened to the joint bolt, wherein the joint bolt has a polygonal neck portion adapted for forcibly fitting into a bolt insertion through a hole in a cable rack so as to bite into an inner peripheral surface of the bolt insertion hole. The nut, to be threadably connected to the bolt, is formed with a screw shaped biting convex portion adapted to be pressed against a surface-finishing film while pushing fractions of the film toward a periphery thereof.

Nonetheless, there still remains a problem in the technique disclosed in Japanese Patent Publication No. 04-004808B, namely, a corotation of the joint bolt and the nut while being fastened to each other. Specifically, in a case where a frictional resistance between an externally-threaded portion of the bolt and an internally-threaded portion of the nut is relatively large, as in the case of a hot-dip galvanized bolt and nut, a torque greater than an axial force (tensile force) is likely to be imposed on the bolt when the nut is rotated, whereby a corotation phenomenon occurs in such a manner that the bolt rotates together with the nut before the neck portion of the bolt is forcibly fitted into the through-hole, which causes a failure in obtaining a tightening force and a function of establishing electrically conduction.

The frequency with which the corotation phenomenon occurs is relatively low in the entire cable-rack joining operation. However, once the corotation phenomenon occurs, it leads to a problem of significantly low efficiency in the cable-rack joining operation. Specifically, in the event that the corotation occurs, even if an operator strongly presses a head of the joint bolt against the through-hole by one of his/her hands, the corotation cannot be stopped because there is no anti-rotation means provided in the through-hole, which gives rise to a need for the operator to rotate the nut by one hand while clamping the bolt head using a tool, such as pliers or pinchers, by the other hand. Such a two-handed operation also can be a problem when done at a high location.

As one of the measures for preventing the corotation, it was tried to fittingly insert the neck portion of the joint bolt into a polygonal hole portion formed in a part of the bolt insertion hole in order to rotationally immobilize the joint bolt. As a result, it was proven that a bite-in function by the neck portion is not performed, i.e., the neck portion becomes unable to bite into an inner peripheral surface of the bolt insertion hole. Specifically, when the joint bolt is immobilized by the hole portion fitted on the neck portion of the joint bolt, the entire outer periphery of the neck portion is brought into close contact with an inner peripheral surface of the hole portion. Thus, the bite-in function of each corner edge of the neck portion is not performed, i.e., it is not possible for the neck portion to bite into the inner peripheral surface of the bolt insertion hole.

In order to solve this problem, the inventor of the present invention also has proposed the technique disclosed in Japanese Patent Laid-open No. 2007-295657A. The technique relates to a cable rack joint structure capable of biting into an inner peripheral surface of a bolt insertion hole to establish sufficient electrical conduction using a particular bolt and nut such as a hot-dip galvanized bolt and nut.

The technique disclosed in Japanese Patent Laid-open No. 2007-295657A is intended to enhance the bite-in function of each corner edge of a polygonal neck portion by modifying a shape of the bolt insertion hole in a noncircular shape. In this case, the bolt insertion hole formed in a cable rack has a noncircular shape, such as a petal-like shape, a star-like shape or a generally square shape. Thus, an operator is likely to have difficulty in recognizing such a noncircular bolt insertion hole as being a proper bolt insertion hole, which leads to confusion in the cable-rack joining work.

Specifically, the corotation of a polygonal neck bolt and a nut occurs in a limited number of cases where a frictional resistance between the bolt and nut is relatively large as in the case of a hot-dip galvanized bolt and nut. In the conventional circular bolt insertion hole as disclosed in Japanese Patent Publication No. 04-004808B, a standard bolt and nut with a usual surface-finish are used. Thus, an operator with no experience in using a particular bolt and nut such as a hot-dip galvanized bolt and nut, has difficulty in understanding that a bolt insertion hole having a noncircular shape such as a petal-like shape or a star-like shape, as disclosed in Japanese Patent Laid-open No. 2007-295657A, is a proper insertion hole. This gives rise to a need for explaining the same operators having questions on an operator-by-operator basis, or for publicity activities so that operators are familiarized with the noncircular shape so they know it is a proper bolt insertion hole. However, the frequency of use of the particular bolt and nut, such as a hot-dip galvanized bolt and nut, is significantly low as compared with the standard bolt and nut. Thus, it is significantly inefficient to spend time and effort in explaining to the operators to familiarize them with the noncircular shape so they know it is a proper bolt insertion hole.

### SUMMARY OF THE INVENTION

In view of the above problems, in a cable rack joint structure designed to bite into an inner peripheral surface of a bolt insertion hole so as to establish sufficient electrical conduction between cable racks, it is an object of the present invention to provide a technique capable of reliably preventing corotation of a bolt and a nut, such as a hot-dip galvanized bolt and nut, while tightly fastening them together, and allowing a shape of a bolt insertion hole to be recognized by operators as being that of a standard bolt insertion hole so as to minimize time and effort needed to explain the same to the operators so that they become familiar therewith so as to so recognize it.

In order to achieve the object, the present invention provides a cable rack joint structure designed to superimpose a splice plate (4) coated with an electrically-nonconductive surface-finishing film (3) on opposed joining end portions of respective primary beams (2) of two cable racks (1), each coated with an electrically-nonconductive surface-finishing film (3), and connect the splice plate (4) and a respective one of the cable racks (1) together using fastening means including an electrically-conductive joint bolt (5) and an electrically-conductive locking nut (7). The joint bolt (6) is provided with a polygonal neck portion (6) tapered toward a distal end thereof, and adapted to be forcibly fitted into an bolt insertion hole (9) formed in the primary beam (2) of a corresponding one of the cable racks (1) so as to bite into an inner peripheral surface of the bolt insertion hole (9) while biting into the surface-finishing film (3) of the corresponding cable rack (1). Further, the locking nut (7) is formed as a flanged nut with serrations adapted to be fastened to the joint bolt (5) in such a manner to bring the serrations (8) into press contact with the splice plate (4) while pushing fragments of the surface-finishing film (3) on the splice plate (4) toward a periphery thereof. The two cable racks (1) become mutually electrically conductive through the fastening means. In the cable rack joint structure, the bolt insertion hole (9) is formed in a circular shape, which allows only a distal end of the neck portion (6) of the joint bolt (5) to be inserted thereinto. The bolt insertion hole (9) has a plurality of recesses (9A) formed in the inner peripheral surface thereof and is adapted to lock respectively at least two of three or more corner edges (6A) of the neck portion (6), in such a manner that the inner peripheral surface of the bolt insertion hole (9) is biting into thereby at respective positions where the corner edges (6A) of the neck portion (6) are locked by corresponding ones of the recesses (9A) (as set forth in the appended claim 1).

Preferably, in the cable rack joint structure of the present invention, the joint bolt (5) is inserted into the bolt insertion hole (9) from an inner side of the primary beam (2), and the locking nut (7) is fastened to the joint bolt (5) from the side of the splice plate (4), wherein an entire surface of each of the joint bolt (5) and the locking nut (7) including a threaded portion thereof is coated with a surface-finishing film having a high frictional resistance, and wherein the surface-finishing film includes a hot-dip galvanizing film (10) (as set forth in the appended claim 2).

In the cable rack joint structure of the present invention, when the neck portion (6) of the joint bolt (5) has a four-sided shape in cross-section, the recesses (9A) may be formed in the inner peripheral surface of the bolt insertion hole (9) at positions lockingly engageable respectively with an adjacent two of four corner edges (6A) of the four-sided neck portion (6) (as set forth in the appended claim 3).

Alternatively, when the neck portion (6) of the joint bolt (5) has a four-sided shape in cross-section, the recesses (9A) may be formed in the inner peripheral surface of the bolt insertion hole at positions lockingly engageable respectively with three of four corner edges of the four-sided neck portion (as set forth in the appended claim 4).

Alternatively, when the neck portion (6) of the joint bolt (5) has a four-sided shape in cross-section, the recesses (9A) may be formed in the inner peripheral surface of the bolt insertion hole (9) at four positions at intervals of 45 degrees about a center of the bolt insertion hole (9) (as set forth in the appended claim 5).

In the cable rack joint structure of the present invention, when the neck portion (6) of the joint bolt (5) has a four or more-sided shape in cross-section, the number of the recesses (9A) is preferably set to be equal to or greater than one-half of a total number of corner edges (6A) of the four or more-sided neck portion (6) when the total number is an even number, and set to be equal to or greater than one-half of a value obtained by subtracting one from the total number when the total number is an odd number (as set forth in the appended claim 6).

As above, in the cable rack joint structure of the present invention, the bolt insertion hole (9) is formed in a circular shape which allows only a distal end of the neck portion (6) of the joint bolt (5) to be inserted thereinto, wherein the bolt insertion hole (9) has a plurality of recesses (9A) formed in an inner peripheral surface thereof and adapted to lock respectively at least two of three or more corner edges (6A) of the neck portion (6), in such a manner that the inner peripheral surface of the bolt insertion hole (9) is bit into thereby at respective positions where the corner edges (6A) of the neck portion (6) are locked by corresponding ones of the recesses (9A). This makes it possible to reliably prevent corotation which otherwise occurs between a bolt and a nut, such as a hot-dip galvanized bolt and nut, while tightly fastening them together. In addition, each of the recesses (9A) is formed in the inner peripheral surface of the circular bolt insertion hole (9) in the form of a slight depression lockingly engageable with a corresponding one of the corner edges (6A). This makes it possible to allow a shape of the bolt insertion hole (9) to be intuitively recognized as being that of a standard bolt insertion hole to minimize the time and effort needed on activities for making operators become familiarized with the bolt insertion hole (9) so they know it is a proper bolt hole.

In the present invention, the joint bolt (5) and the locking nut (7) having a particular surface-finishing film, such as a hot-dip galvanizing film, coated on the entire surface including a threaded portion thereof (as set forth in the appended claim 2), can be effectively used while reliably preventing a corotation phenomenon which particularly occurs due to a relatively large frictional resistance between external threads of the joint bolt (5) and internal threads of the locking nut (7).

According to the configuration/arrangement (as set forth in each of the appended claims 3 to 6), in a state after the corner edges (6A) of the joint bolt (5) are locked by the respective recesses (9A) of the bolt insertion hole (9), the inner peripheral surface of the bolt insertion hole (9) can be bitten into thereby at the respective recesses (9A) locking the corner edges (6A). Thus, in the cable rack joint structure, the inner peripheral surface of the bolt insertion hole (9) can be bitten into in order to assure establishment of electrical conduction between the cable racks (1). In addition, each of the recesses (9A) is formed in the inner peripheral surface of the circular bolt insertion hole (9) at several positions in the form of a slight depression. Thus, an operator with no experience of using a particular bolt and a nut, such as a hot-dip galvanized bolt and nut, can use the bolt insertion hole (9) in the cable rack joint structure of the present invention, without any particular explanations about the bolt insertion hole (9) being needed, in the same manner as that in a conventional bolt insertion hole P. This makes it possible to fully eliminate the need to inefficiently spend time and effort explaining to operators one by one, or carrying out publicity activities to familiarize the operators with, the shape of the bolt insertion hole (9) so they know it is a proper bolt hole.

Thus, in the cable rack joint structure designed to bite into the inner peripheral surface of the bolt insertion hole by the bolt so as to establish sufficient electrical conduction between cable racks, the present invention has an advantage of being able to reliably prevent corotation which occurs between the bolt and nut, such as a hot-dip galvanized bolt and nut, during an operation of tightly fastening them together, and allowing the shape of the bolt insertion hole to be intuitively recognized as being that of a standard bolt insertion hole so as to minimize the need for spending the time and effort to familiarize operators with the bolt insertion hole so they know it is a proper one.

### BRIEF DESCRIPTION OF THE DRAWINGS

FIG. 1 is an exploded perspective view showing a cable rack joint structure according to one embodiment of the present invention during use.

FIG. 2 is a fragmentary sectional view showing the cable rack joint structure in FIG. 1.

FIG. 3 is a side view showing a joint bolt in FIG. 1.

FIG. 4 is a front view showing the joint bolt in FIG. 3.

FIGS. 5A and 5B illustrate a locking nut in FIG. 1, wherein FIG. 5A is a side view, and FIG. 5B is a front view.

FIG. 6 is a fragmentary broken-out sectional view showing a state in which an inner peripheral surface of a bolt insertion hole in FIG. 1 is bitten into by a bolt.

FIG. 7 is a fragmentary sectional view showing a polygonal neck portion of the joint bolt and the bolt insertion hole in FIG. 1.

FIG. 8 is a top plan view showing another example of the bolt insertion hole.

FIG. 9 is a top plan view showing yet another example of the bolt insertion hole.

FIG. 10 is a top plan view showing still another example of the bolt insertion hole, together with a conventional bolt insertion hole.

FIGS. 11a and 11b illustrate experimental bolt insertion holes, wherein FIG. 11a is a top plan view showing a bolt insertion hole formed with one recess, and FIG. 11b is a top plan view showing a bolt insertion hole formed with two recesses.

### DESCRIPTION OF THE PREFERRED EMBODIMENTS

A preferred embodiment of the present invention is directed to achieving the desired object thereof in the following manner. A bolt insertion hole is formed in a circular shape so that only a distal end of a polygonal neck portion of a joint bolt can be inserted thereinto. Further, the bolt insertion hole has a plurality of recesses formed in an inner peripheral surface thereof and adapted to lock respectively at least two of three or more corner edges of the neck portion, in such a manner that they bite into an inner peripheral surface of the bolt insertion hole at respective positions of the corner edges thereof whereby the corner edges of the neck portion are locked by the corresponding ones of the recesses. When the neck portion of the joint bolt has a four-sided shape in cross-section, the recesses are formed in the inner peripheral surface of the bolt insertion hole at positions lockingly engageable respectively with an adjacent two of the four corner edges of the four-sided neck portion.

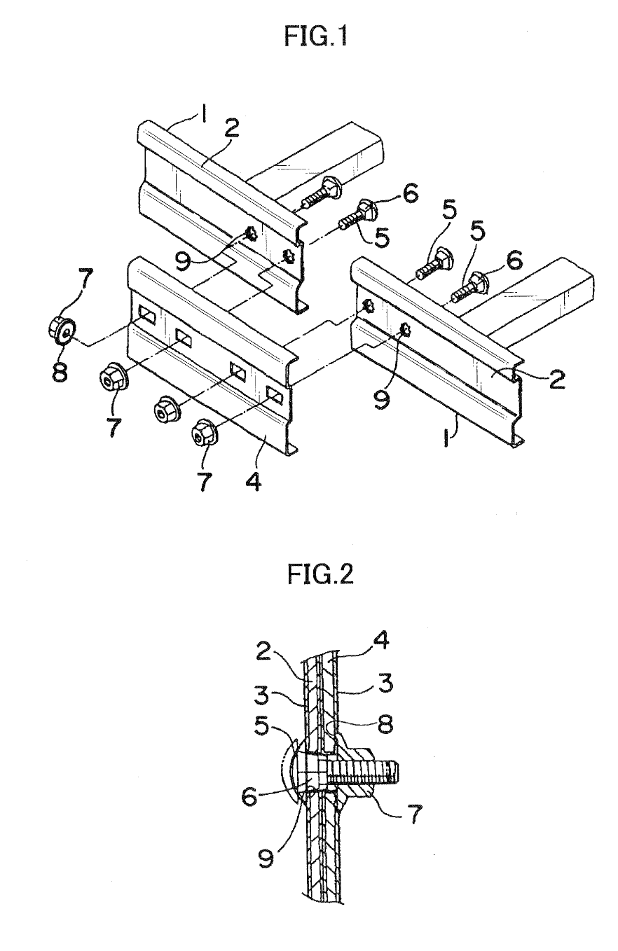

With reference to the drawings, the present invention will now be specifically described as regards one embodiment thereof. A joint structure according to this embodiment is designed to join a plurality of cable racks 1 in a mutually electrically conductive manner. Specifically, as shown in FIG. 1, the joint structure is designed to superimpose a splice plate 4, coated with an electrically-nonconductive surface-finishing film 3, on opposed joining end portions of respective primary beams 2 of two cable racks 1, each coated with an electrically-nonconductive surface-finishing film 3, and to connect the splice plate 4 and a respective one of the cable racks 1 together, using an electrically-conductive joint bolt 5 and an electrically-conductive locking nut 7.

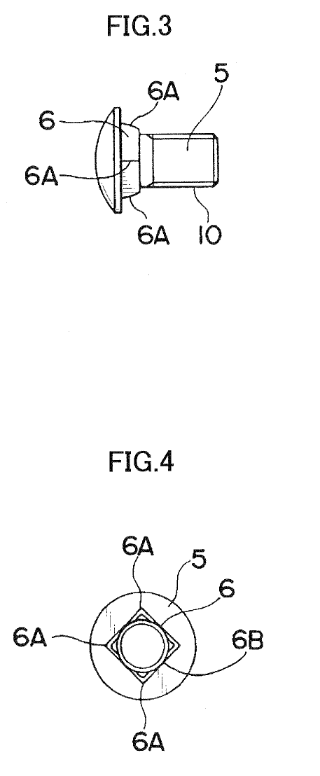

As shown in FIG. 3, the joint bolt 5 has a tapered polygonal neck portion 6 formed on a lower portion of the side surface of a head thereof and tapered toward a distal end thereof. As shown in FIG. 4, the neck portion 6 is formed in a generally square shape to have four side surfaces 6B and four corner edges 6A when seen in a top plan view. An entire surface of the joint bolt 5 including an externally-threaded portion thereof is coated with a surface-finishing film having a relatively high frictional resistance, such as a hot-dip galvanizing film 10. In the illustrated embodiment, the joint bolt 5 is formed using a cup square neck bolt (8×15), which is commonly used in joining cable racks 1.

As shown in FIGS. 5A and 5B, the locking nut 7 is a flanged nut with serrations 8. The entire surface of the locking nut 7 including an internally threaded portion thereof is also coated with a surface-finishing film having a relatively high frictional resistance, such as a hot-dip galvanizing film 10. In the illustrated embodiment, the locking nut 7 is a serrated flanged nut (M8), which is commonly used in joining cable racks 1.

In an operation of joining the cable racks 1 together, the joint bolt 5 is inserted into a bolt insertion hole 9 formed in a corresponding one of the primary beams 2 from an inner side of the primary beam 2, and then the locking nut 7 is fastened to the joint bolt 5 from the side of the splice plate 4 disposed on an outside of the primary beam 2 (see FIG. 1). While tightening the locking nut 7 against the joint bolt 5, the corner edges of the neck portion 6 of the joint bolt 5 forcibly bite into the inner peripheral surface of the bolt insertion hole 9 while biting into the surface-finishing film 3 on the inner peripheral surface of the bolt insertion hole 9. Concurrently, the serrations 8 of the locking nut 7 are brought into press contact with the splice plate 4 while pushing fragments of the surface-finishing film 3 on the splice plate 4 toward a periphery thereof (see FIG. 2). In this manner, an electrical conduction between the cable racks 1 is established.

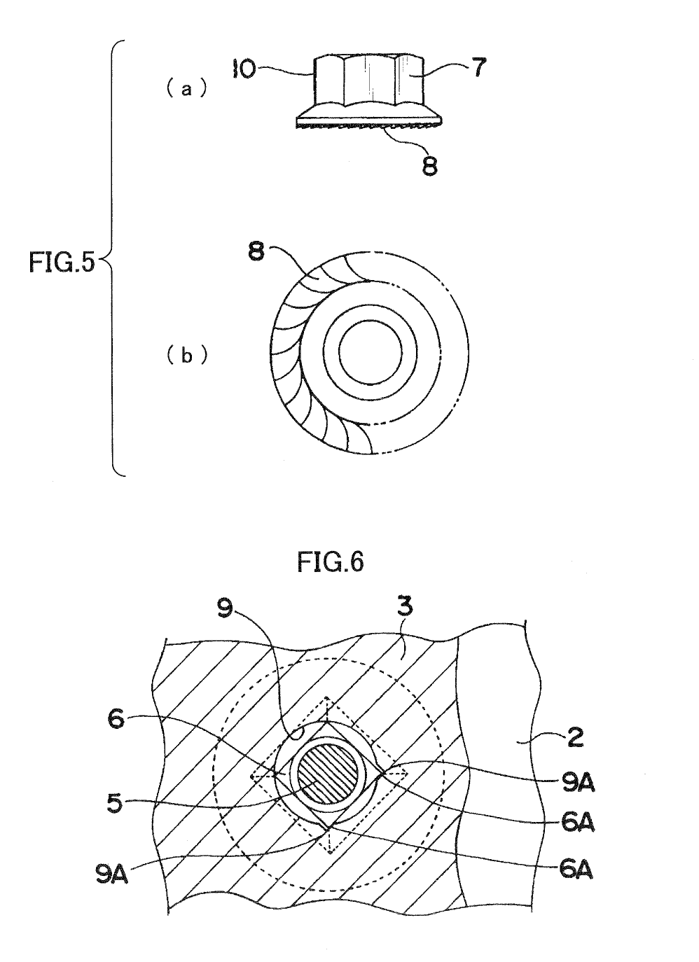

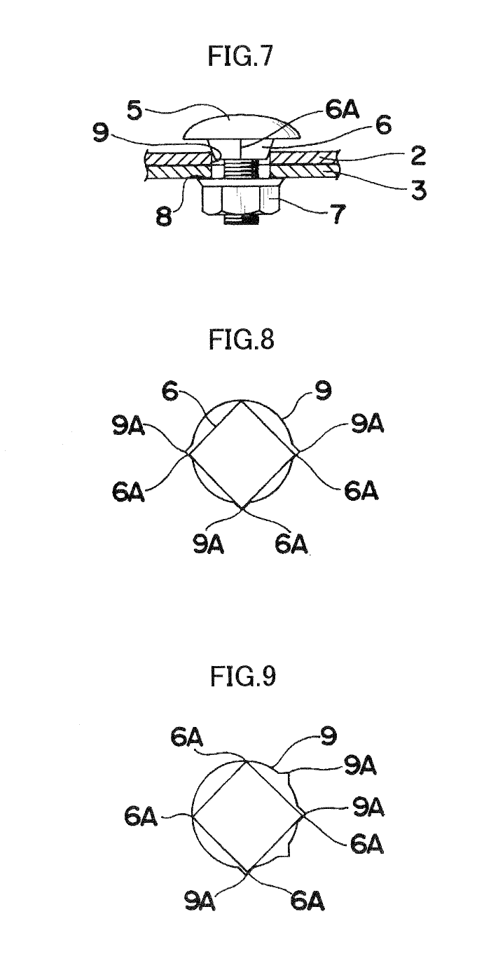

The joint structure according to the embodiment is an improvement in the shape of the bolt insertion hole 9. Specifically, as shown in FIG. 6, the bolt insertion hole 9 is formed in a circular shape so as to allow only a distal end of the neck portion 6 of the joint bolt 5 to be inserted thereinto. Further, the bolt insertion hole has two recesses 9A formed in the inner peripheral surface thereof and adapted to lock respectively two of the four corner edges of the neck portion 6, in such a manner that the inner peripheral surface of the bolt insertion hole 9 is bitten into at respective positions where the corner edges 6A of the neck portion 6 are locked by corresponding ones of the recesses 9A.

More specifically, the bolt insertion hole 9 is formed to have a diameter, which allows only the distal end of the neck portion 6 of the joint bolt 5 to be insertable thereinto. Further, the bolt insertion hole 9 is formed such that portions of the corner edges 6A of the neck portion 6 inserted into the bolt insertion hole 9 are lockably engaged with the respective recesses 9A of the bolt insertion hole 9. As shown in FIG. 11a, in a case where the bolt insertion hole 9 is formed with one recess 9A, it was experimentally verified that an opposed two of the corner edges 6A of the neck portion 6 are brought into contact with the inner peripheral surface of the bolt insertion hole 9, so that an axis of the joint bolt 5 is kept in alignment with an axis of the bolt insertion hole 9 to preclude displacement of the neck portion 6 toward the recess 9A. Consequently, non of the corner edges 6A is lockingly engaged with the recess 9A. Thus, corotation of the joint bolt 5 and locking nut 7 cannot be prevented.

As shown in FIG. 11b, in a case where the bolt insertion hole 9 is formed with two recesses 9A at positions lockingly engageable with an adjacent two of the corner edges 6A of the neck portion 6, it was verified that the neck portion 6 moved within the bolt insertion hole 9 so that the two corner edges slidably fitted into the respective recesses 9A. This makes it possible to prevent the corotation of the joint bolts and locking nut.

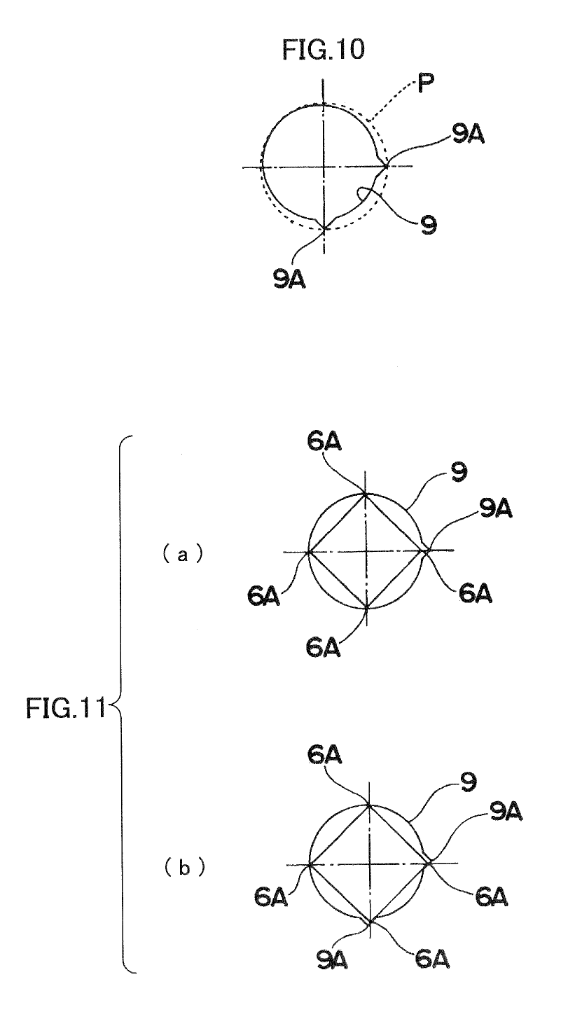

In conventional cable racks, a diameter of a bolt insertion hole P is typically set at 10.5 mm (see FIG. 10). On the other hand, in the cable rack 1 in the embodiment, the bolt insertion hole 9 is formed to have a diameter of 10 mm to allow only the distal end of the neck portion 6 to be insertable thereinto. Further, each of the recesses 9A is formed in the bolt insertion hole 9 such that a maximum distance between the center of the bolt insertion hole 9 and a bottom of the recess 9A is set at 10.5 mm. In FIG. 10, the two recesses 9A are located at intervals of 90 degrees about the center of the bolt insertion hole 9. Further, each of the recesses 9A has a cross-sectional shape, which is defined by two linear lines intersecting approximately at a right angle.

Some examples of modification of the bolt insertion hole shall be described below. As shown in FIG. 8, in a case where the joint bolt 5 is provided with a polygonal neck portion 6 having a four-sided (square) shape in cross-section, the recesses 9A are formed in the inner peripheral surface of the bolt insertion hole 9 at positions lockingly engageable respectively with three of four corner edges of the four-sided neck portion 6. In this case, the three corner edges 6A will be lockably engaged respectively with the three recesses 9A.

Alternatively, as shown in FIG. 9, in a case where the joint bolt 5 is provided with a polygonal neck portion 6 having a four-sided (square) shape in cross-section, the recesses 9A are formed in the inner peripheral surface of the bolt insertion hole 9 at four positions at intervals of 45 degrees about the center of the bolt insertion hole 9. In this case, an adjacent two of the corner edges 6A will be lockably engaged respectively with two of the four recesses 9A.

Further, it was experimentally proven that it is preferable that the recesses 9A be formed at positions allowing two adjacent corner edges 6A to be lockably engaged therewith at the same time, and the number of the recesses 9A lockingly engageable with the corner edges 6A of the neck portion 6 is preferably set to be equal to or greater than one-half of a total number of the corner edges 6A.

Specifically, when a total number of the corner edges 6A of the neck portion 6 is an even number, it is preferable that the recesses 9A be formed at positions allowing at least two adjacent corner edges 6A to be lockably engaged therewith at the same time, and the number of the recesses 9A lockingly engageable with the corner edges 6A is set to be equal to or greater than one-half of the total number of the corner edges 6A. For example, the neck portion 6 of the joint bolt 5 is a hexagonal (six-sided) shape wherein the number of the recesses 9A is set to be three or more (not shown).

When a total number of the corner edges 6A of the neck portion 6 is an odd number, it is preferable that the recesses 9A be formed at positions, allowing at least two adjacent corner edges 6A to be lockably engaged therewith at the same time, and the number of the recesses 9A lockingly engageable with the corner edges 6A is set to be equal to or greater than one-half of a value derived by subtracting one from the total number of the corner edges 6A. For example, the neck portion 6 of the joint bolt 5 is a heptagonal (seven-sided) shape, and the number of the recesses 9A is set to be three or more, although not illustrated.

In the joint structure according to the above embodiment, instead of allowing the entire neck portion 6 to be fitted into the bolt insertion hole 9, only the corner edges of the neck portion 6 are locked by the respective recesses 9A. Thus, the recesses 9A may be formed so as to simultaneously lock all the corner edges 6A.

An advantageous embodiment of the present invention has been shown and described. It is obvious to those skilled in the art that various changes and modifications may be made therein without departing from the spirit and scope thereof as set forth in appended claims. For example, the recess 9A of the bolt insertion hole 9 or the neck portion 6 of the joint bolt 5 may be formed in any other suitable shape as needed.

1. A cable rack joint structure for joining a splice plate and two cable racks, wherein each of said two cable racks has a primary beam, and said splice plate is superimposed on said primary beams at end portions opposed thereto, comprising:
said splice plate and said primary beams, each being coated with an electrically-nonconductive surface-finishing film, and said splice plate being connected to said primary beams at said end portions thereof by an electrically-conductive joint bolt and an electrically-conductive locking nut, said joint bolt having a polygonal neck portion tapered toward a distal end thereof, an bolt insertion hole being formed in said primary beam, said joint bolt being adapted to be forcibly fitted into said bolt insertion hole so as to bite into an inner peripheral surface of said bolt insertion hole so that said surface-finishing film of said cable rack is broken, said locking nut having a flange with serrations, which are pressed against said splice plate while pushing fragments of said surface-finishing film on said splice plate toward a periphery thereof while said locking nut is threadably connected to said bolt, whereby said two cable racks become mutually electrically conductive,
said bolt insertion hole being formed in a circular shape so that only a distal end of said neck portion of said joint bolt can be inserted thereinto, said bolt insertion hole having a plurality of recesses formed in said inner peripheral surface thereof and adapted to lock at least two out of three or more corner edges of said neck portion, which bite into said inner peripheral surface of said bolt insertion hole at respective positions where said corner edges of said neck portion are locked by corresponding ones of said recesses.

2. The cable rack joint structure as recited in claim 1, wherein said joint bolt is inserted into said bolt insertion hole from an inner side of said primary beam, and said locking nut is fastened to said joint bolt from the side of said splice plate, and
wherein an entire surface of each of said joint bolt and said locking nut including a threaded portion thereof is coated with a surface-finishing film of high frictional resistance, said surface-finishing film including a hot-dip galvanizing film.

3. The cable rack joint structure as recited in claim 1, wherein said neck portion of said joint bolt has a four-sided shape in cross-section, and
wherein said recesses are formed in said inner peripheral surface of said bolt insertion hole at positions lockingly engageable respectively with an adjacent two of four corner edges of said four-sided neck portion.

4. The cable rack joint structure as recited in claim 1, wherein said neck portion of said joint bolt has a four-sided shape in cross-section, and
wherein said recesses are formed in said inner peripheral surface of said bolt insertion hole at positions lockingly engageable respectively with three of four corner edges of said four-sided neck portion.

5. The cable rack joint structure as recited in claim 1, wherein said neck portion of said joint bolt has a four-sided shape in cross-section, and
wherein said recesses are formed in said inner peripheral surface of said bolt insertion hole at four positions at intervals of 45 degrees about a center of said bolt insertion hole.

6. The cable rack joint structure as recited in claim 1, wherein said neck portion of said joint bolt has a four or more-sided shape in cross-section, and
wherein a number of said recesses is set to be equal to or greater than one-half of a total number of corner edges of said four or more-sided neck portion when said total number is an even number, and set to be equal to or greater than one-half of a value derived by subtracting one from said total number when said total number is an odd number.

7. The cable rack joint structure as recited in claim 2, wherein said neck portion of said joint bolt has a four-sided shape in cross-section, and
wherein said recesses are formed in said inner peripheral surface of said bolt insertion hole at positions lockingly engageable respectively with an adjacent two of four corner edges of said four-sided neck portion.

8. The cable rack joint structure as recited in claim 2, wherein said neck portion of said joint bolt has a four-sided shape in cross-section, and
wherein said recesses are formed in said inner peripheral surface of said bolt insertion hole at positions lockingly engageable respectively with three of four corner edges of said four-sided neck portion.

9. The cable rack joint structure as recited in claim 2, wherein said neck portion of said joint bolt has a four-sided shape in cross-section, and
wherein said recesses are formed in said inner peripheral surface of said bolt insertion hole at four positions at intervals of 45 degrees about a center of said bolt insertion hole.

10. The cable rack joint structure as recited in claim 2, wherein said neck portion of said joint bolt has a four or more-sided shape in cross-section, and
wherein a number of said recesses is set to be equal to or greater than one-half of a total number of corner edges of said four or more-sided neck portion when said total number is an even number, and set to be equal to or greater than one-half of a value derived by subtracting one from said total number when said total number is an odd number.
